(19) United States
(12) Patent Application Publication
(10) Pub. No.: US 2011/0137692 A1
(43) Pub. Date: Jun. 9, 2011

(54) SYSTEM AND METHOD FOR BOARDING PASSENGERS BASED ON VALUATION DATA

(76) Inventor: Shaun Beheruz Sethna, Houston, TX (US)

(21) Appl. No.: 13/025,024

(22) Filed: Feb. 10, 2011

Related U.S. Application Data
(63) Continuation-in-part of application No. 12/221,734, filed on Aug. 6, 2008.

(51) Int. Cl. G06Q 10/00; G06Q 30/00

(52) U.S. Cl. 705/5

(57) ABSTRACT

Systems and methods for boarding passengers on flights or other transportation according to bids and/or locations received from the passengers are provided. Passengers seeking to fly standby on an undersold flight can submit a bid representing the amount they are willing to pay to board the flight. The airline can determine the number of seats available on the flight, and board the highest bidding passengers until the flight is full. Similarly, passengers willing to be bumped from an oversold flight can submit a bid representing the incentive the passengers are willing to accept to be bumped from the flight. The airline can then bump the lowest bidding passengers until a sufficient number of passengers have been bumped from the flight. Airlines also can determine the locations of passengers and transmit offers or counter-offers for standby fares or bump incentives based on the locations.

### CROSS-REFERENCE TO RELATED APPLICATIONS

This application is a continuation-in-part of U.S. patent application Ser. No. 12/221,734 titled “System and Method for Boarding Passengers Based on Bids,” filed on Aug. 6, 2008, the complete disclosure of which is hereby incorporated by reference herein.

### TECHNICAL FIELD

The invention relates to systems and methods for identifying a valuation of boarding passengers, and then boarding passengers based on those valuations. More particularly, the invention relates to receiving valuation data such as bids and/or locations from passengers—such as airline passengers—seeking to travel standby or willing to be “bumped” from their reserved seat and selecting which passengers to board based on that data.

### BACKGROUND

Airlines and other transportation carriers generally seek to maximize the number of passengers on each flight. Empty seats can represent lost revenue, and the marginal cost incurred by an airline by boarding an extra passenger is relatively small. Thus, minimizing the number of empty seats on a flight can maximize the profit for the airline.

Because of the lost revenue associated with empty seats on a given flight, airlines generally sell a greater number of tickets for a flight than there are total seats. The airlines assume that at least a portion of the tickets will go unused, and therefore overselling can help the airline minimize the number of empty seats on each flight.

Except in the rare case where an airline will successfully oversell a flight by the precisely correct number of seats, as flights approach their departure time there are generally either too many or too few passengers ready to board the flight. For example, if the airline oversold the flight, and in doing so, overestimated the number of passengers that would cancel their reservation, the flight is considered overbooked or oversold. In such cases, certain passengers, even though they may have boarding passes for the flight, may be asked to give up their seats on the flight and board a different flight to their destination, otherwise known as “bumping” the passenger from their original flight.

In other cases, flights may be underbooked or undersold. This may be because the airline oversold the flight but underestimated the number of passengers that would cancel their reservation. Alternatively, the airline may not have oversold the flight in the first place. Regardless of the reason, when a given flight is undersold, the airline may allow other passengers to board the flight, even if they did not have a ticket for the flight. Often times, these so-called passengers may have a ticket for a later flight to the same destination on the same airline, but have arrived in time to catch the earlier flight and seek to fly standby on the earlier flight. These standby passengers can board the earlier flight and give up their seat on the later flight. This can be advantageous to the airline because it reduces the number of empty seats on the earlier flight, and allows the airline additional time to replace the passenger's seat on the later flight.

Conventional policies for boarding standby passengers on undersold flights and “bumping” passengers from oversold flights can vary. For example, conventional airlines often charge a fee to standby passengers, in an attempt to capture extra revenue from passengers seeking to change their flight. Conversely, when determining which passengers to bump from oversold flights, airlines often provide a voucher or other financial incentive to passengers willing to give up their seats in exchange for seats on a later flight.

These conventional policies and methods for charging fees to standby passengers and providing financial incentives to those passengers willing to give up their seats both pose certain problems for airlines. For example, airlines charging fees for standby passengers often struggle to determine the optimal standby fee. They often must use principles of supply and demand to set a fee sufficiently high to generate significant revenue, but not so high to deter a significant number of passengers from flying standby. This optimal fee can be difficult to estimate, and any fee other than the optimal fee can result in lost profits. Furthermore, setting one optimal—or even near optimal—fee for all flights can be impossible, given that different flights of an airline may have vastly different passenger demands based on a variety of factors such as the routes, time of year, and time of departure for the flight.

With respect to incentivizing passengers willing to be bumped from their flights, airline policies generally involve offering a certain incentive to passengers to exchange their seat for a later flight, and repeatedly increasing the incentive until a sufficient number of passengers have given up their seats. According to conventional airline policies, all bumped passengers may receive the identical incentives, equal to the latest (and highest) amount offered by the airline. Thus, under the conventional model, some passengers may receive a greater financial incentive than what they would be willing to accept to give up their seats, thus representing an extra cost to the airline.

Another deficiency with the conventional model for providing financial incentives to bumped passengers is that the airline generally announces the type and amount of financial incentive and the number of seats by which the flight has been oversold. This often occurs at the departure gate for the flight, with willing passengers approaching the airline staff to accept a given financial incentive. This model can allow passengers to see how many seats are needed, and how many passengers have given up their seats. Passengers thus can try to “game” the system, by waiting for the incentive to increase until it seems that almost enough passengers have given up their seats before giving up theirs, even if they would have been willing to take a lower financial incentive to do so. This behavior, allowed by the conventional model, also can result in increased cost to the airline.

Yet another deficiency with conventional models for selecting passengers to board undersold and oversold flights is the failure to account for a location of the passengers. The location of a passenger—such as whether a passenger is still at home or at the airport—can affect the passenger's valuation of being on a particular flight. For example, a passenger already at the airport to board a scheduled flight may place a higher value on keeping the original reservation (and thus desire more compensation to be bumped from that reservation) than a passenger who has not left home for the flight.

Thus, a need in the art exists for a system and method for determining which standby passengers to board an undersold flight and for determining which passengers to bump from an oversold flight that lacks the deficiencies associated with conventional models.

Specifically, a need in the art exists for a method for determining which standby passengers to board a flight that reduces or eliminates the need for an airline to determine a set standby fee to charge passengers. A need in the art also exists for a method for determining which standby passengers to board a flight that increases the airline's profits by accounting for the different supply and demand for standby seats on different flights. Another need in the art exists for a method for determining which passengers to bump from an oversold flight that reduces the extra costs to the airline associated with providing each bumped passenger with the same financial incentive. Yet another need in the art exists for a method for determining which passengers to bump from an oversold flight that reduces the costs associated with passengers knowing the financial incentives that other passengers are willing to accept to be bumped from the flight. Additionally, another need in the art exists for taking into account other factors affecting the valuation passengers may place on being on a particular flight, such as the location of the passenger.

### SUMMARY OF THE INVENTION

The invention described herein can provide a system and method for seating passengers on oversold and undersold flights or other transportation that address the deficiencies in the prior art. Specifically, the inventions can determine a valuation for the passengers and the transportation provider for placing passengers on particular flights. This can include receiving bids and/or locations from ticketed or potential passengers, and determine which of those passengers to board on a flight based on those bids and/or locations.

In one aspect, the invention can provide a system and method for receiving bids from passengers seeking to fly standby on an undersold flight, and determining which of those passengers to board on the flight. After determining that a flight has been undersold (i.e., that empty seats would remain after boarding all ticketed passengers), the airline can announce to standby passengers that seats are available on the flight. The airline can invite interested standby passengers to submit a bid, representing the amount of money that the passengers would be willing to pay to be seated on the flight.

After receiving bids from the standby passengers, the airline can determine how many seats are available on the flight. The airline then can select the highest bid, board the passenger who submitted the highest bid, and continue boarding passengers in descending order of the bid they submitted until the flight is full. For example, if there are forty total seats on a flight and there are thirty ticketed passengers, the airline can board the standby passengers who submitted the ten highest bids.

Boarding standby passengers according to the bids they submitted can increase the revenue and/or profits to the airline when compared to conventional systems and methods. By allowing each standby passenger to submit a bid, the need for the airline to set a predetermined standby fee is removed. Such a system therefore can reduce or remove the problems of setting a standby fee too low (thereby forgoing revenue on high demand flights where passengers would be willing to pay more than the standby fee) or too high (thereby forgoing revenue on lower demand flights where passengers would be willing to pay less than the standby fee). Receiving bids from the passengers can automatically adjust the standby fees charged to the passengers for the relative supply and demand for a given flight. Only the highest bidding passengers will obtain seats on high demand flights. Conversely, on lower demand flights where many seats are available, more seats may be filled with standby passengers as long as they are willing to bid on the seats, even if some passengers bid less than a conventional airline's standby fee.

In another aspect, the invention can provide a system and method for receiving bids from ticketed passengers on an oversold flight, and determining which of those passengers to move or bump from the flight based on the passengers' bids. After determining that an airline's flight is oversold, the airline can announce to the passengers of the flight that it is oversold, and that passengers may volunteer to be bumped from the flight. The airline can invite interested passengers to submit a bid, representing the incentive that the passenger would accept to be bumped from the flight. The bids received by the passengers can include a monetary reward, such as a cash payment or a voucher to use on future travel for the airline. The bid also can include a request for a replacement seat on a specific later flight to the passenger's destination.

After receiving the bids from the passengers, the airline can determine how many passengers it needs to bump from the flight by subtracting the total number of seats on the flight from the number of ticketed passengers for the flight. The airline then can sort the bids according to the value of the bids. The airline then can select the lowest bid, bump the passenger who submitted the lowest bid, and provide the appropriate incentive to the bumped passenger. Providing the incentive to the bumped passenger can include paying the passenger the value of the passenger's bid, as well as providing a confirmed ticket and/or boarding pass for the specific later flight selected by the passenger. The airline then can continue bumping passengers and providing appropriate incentives to the bumped passengers in ascending order of the bid they submitted until a sufficient number of passengers have been bumped from the flight.

Bumping passengers according to the bids they submitted can reduce the costs and/or increase the profits to the airline when compared to conventional systems and methods. By allowing ticketed passengers to submit a bid corresponding to the incentive they would accept to be bumped from the oversold flight, the need for the airline to announce a incentive and gradually increase the incentive until a sufficient number of passengers have been bumped is removed. Such a system therefore can reduce or remove the problem of rewarding an identical incentive to all bumped passenger, and instead can provide each passenger the minimum incentive that the passenger is willing to accept.

Bids from ticketed passengers willing to be bumped from a flight, as well as bids from standby passengers seeking to board a flight, can be received by the airline in secret, such that passengers may not be aware of other passenger's bids. Additionally, when an airline announces to the passengers that seats are available for standby bidding, the airline may not announce to the passengers the number of seats standby seats available. Similarly, when an airline announces that a flight is oversold, the airline may not announce to the number of passengers that need to be bumped from the flight. By not announcing the number of seats in these situations, passengers may be more likely to submit an accurate bid, rather than hoping to “game” the system. For example, if a passenger seeking to fly standby knows that the desired flight has a relatively large number of seats available, the passenger may submit a bid lower than what the passenger is truly willing to pay, hoping that the passenger would nonetheless be able to secure one of the available seats. Similarly, if a passenger on an oversold flight knows that the airline needs to bump a relatively large number of passengers from the flight, the passenger may submit a bid higher than what the passenger is truly willing to accept. If the same passenger did not know the number of seats available, the passenger may be more inclined to submit the true bid, to improve the chances of obtaining a seat.

In yet another aspect, the location of passengers can be taken into account in determining the valuation of the passenger in being on a particular flight. Location can be considered both for identifying passengers who may want to be on a standby list for a different (undersold) flight and confirmed passengers on an oversold flight who may be more likely to be willing to be bumped from their flight.

These and other aspects, objects, and features of the present invention will become apparent from the following detailed description of the exemplary embodiments, read in conjunction with, and reference to, the accompanying drawings.

### BRIEF DESCRIPTION OF THE DRAWINGS

FIG. 1 is a block diagram depicting a system for receiving bids from passengers seeking to fly standby on an undersold flight and from passengers willing to be bumped from an oversold flight, according to an exemplary embodiment of the invention.

FIG. 2 is a flow chart depicting a method for selecting passengers to board a flight, according to an exemplary embodiment of the invention.

FIG. 3 is a flow chart depicting a method for checking the availability of seats on a flight, according to an exemplary embodiment of the invention. FIG. 4 is a flow chart depicting a method for determining which standby passengers to add to a flight based on standby bids, according to an exemplary embodiment of the invention.

FIG. 5 is a flow chart depicting a method for receiving a standby bid for a passenger seeking to fly standby on a flight, according to an exemplary embodiment of the invention.

FIG. 6 is a flow chart depicting a method for determining which passengers to bump from a flight based on bump bids, according to an exemplary embodiment of the invention.

### DETAILED DESCRIPTION OF THE EXEMPLARY EMBODIMENTS

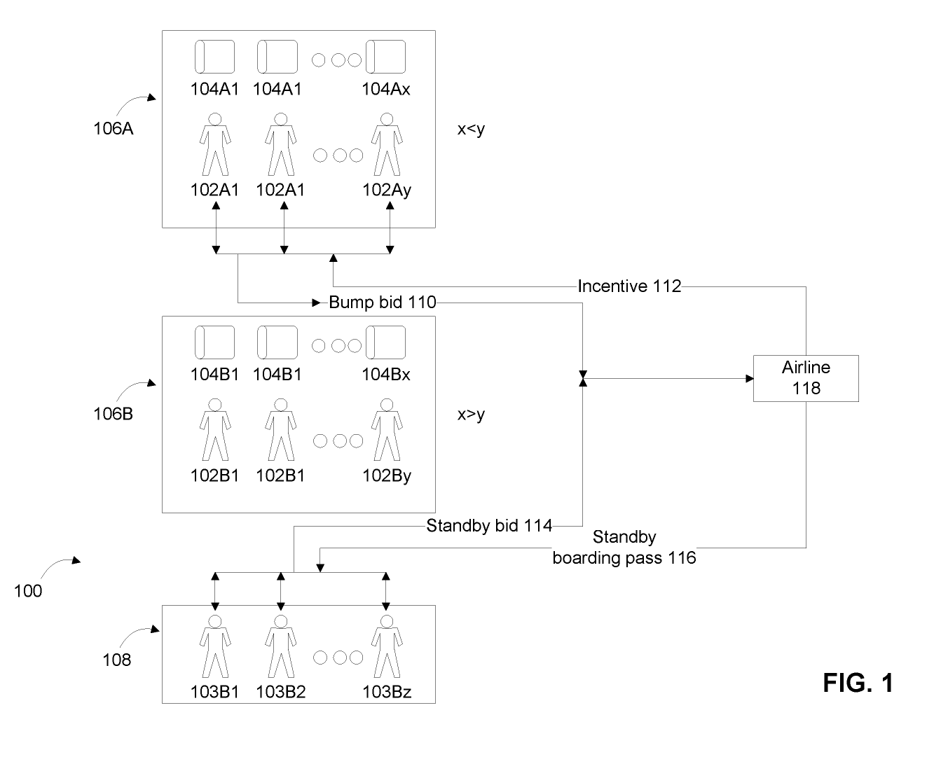

The invention enables airlines or other transportation providers to receive bids (or other data indicative of a valuation to be on a transportation vehicle as described in more detail below) from ticketed or standby passengers, and to use those bids to determine which passengers to board on an oversold or undersold flight (or other similar transportation vehicles). A method and system for receiving bids from passengers and determining which passengers to board a flight will now be described with reference to FIGS. 1-6, which depict representative or illustrative embodiments of the invention. It is understood that in addition to (or instead of) bids 110, 114, any other type of data that is indicative of the valuation that a passenger may have for being on a flight 106 can be used, and that the use of bids 110, 114 as described in the below Figures is an example only.

FIG. 1 is a diagram depicting components of a system 100 for receiving bids from passengers 102, 103B according to an exemplary embodiment of the invention. The exemplary system 100 depicted in FIG. 1 includes an airline 118 with two exemplary flights: an oversold flight 106A and an undersold flight 106B. Each flight 106A, 106B includes a number of total seats 104A, 104B, and a number of passengers 102A, 102B with a confirmed seat or checked in for the flights 106A, 106B. In the oversold flight 106A, the number of passengers 102A exceeds the number of seats 104A on the flight 106A. In the undersold flight 106B, the number of seats 104B exceeds the number of passengers 102B. FIG. 1 additionally depicts a standby list 108 including standby passengers 103B desiring to board the undersold flight 106B.

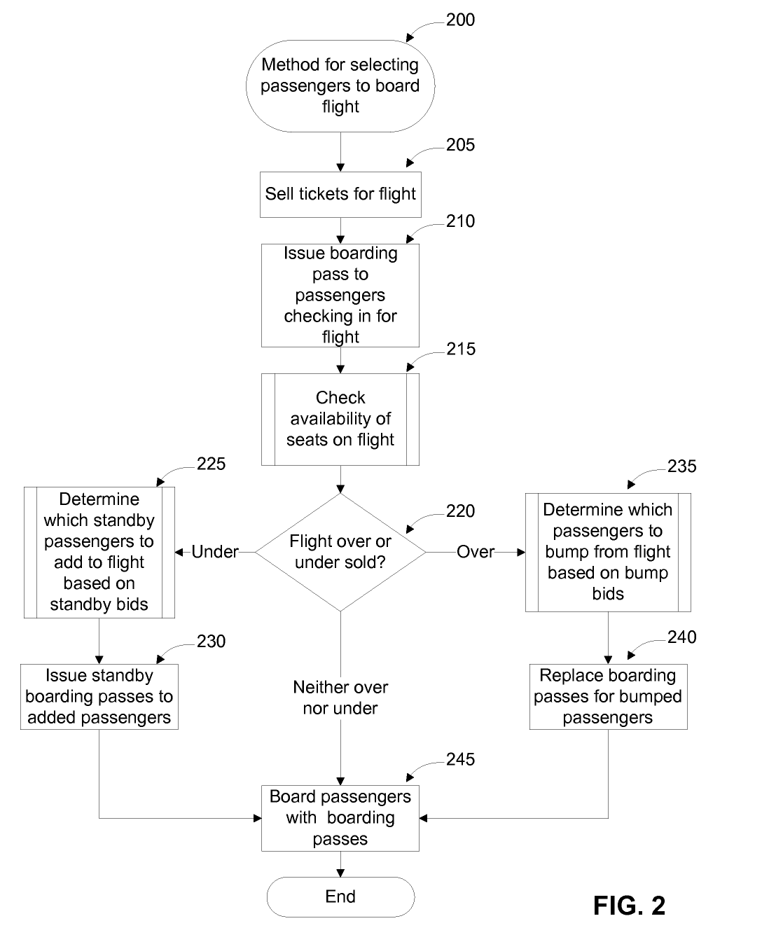

The exemplary system 100 further depicts communication of a bump bid 110 from passengers 102A on the oversold flight 106A to the airline 118, and communication of a standby bid 114 from the passengers 103B on the standby list 108 to the airline 118. FIG. 1 further depicts incentives 112 being provided to certain passengers 102A on the first flight 106A and standby boarding passes 116 being provided to certain passengers 103B on the standby list 108 for the second flight 106B. In accordance with exemplary embodiments, a portion of the passengers 102A on the oversold flight 106A may be bumped from the flight 106A, and a portion of the passengers 103B on the standby list 108 may be allowed to board the undersold flight 106B. The airline 118 can determine which passengers 102A to bump and which standby passengers 103B to board based on bump bids 110 and standby bids 114, respectively, received from the passengers 102A, 103B. The elements depicted in FIG. 1 will be discussed in more detail with reference to the methods illustrated in FIGS. 2-6.

FIG. 2 is a flow chart depicting a method 200 for selecting passengers 102, 103B to board a flight 106, according to an exemplary embodiment of the invention. In step 205, the airline 118 sells tickets to the flight 106. The airline 118 can sell tickets to the flight 106 according to various exemplary methods known to one of ordinary skill in the art having the benefit of the present disclosure. For example, the airline 118 can sell tickets to the flight 106 via the Internet, such as through the airline's 118 website. Alternatively, or additionally, the airline 118 can sell tickets to the flight 106 at kiosks, over the phone, in or near an airport, or at a physical office of the airline 118.

Regardless of the particular method for selling tickets, the tickets sold by the airline 118 can be electronic or physical. Additionally, the airline 118 can sell tickets to the flight 106 according to different fares or fare classes. For example, the airline 118 can sell both refundable and non-refundable tickets to the flight 106, with refundable tickets being more expensive. Additionally, the fare class of the ticket, and therefore the price of the ticket, may vary based on the time the ticket is purchased. For example, tickets may get more expensive as the date of the flight 106 approaches.

In step 210, the airline 118 issues boarding passes to passengers 102 checking in for the flight 106. These passengers 102 can be those passengers 102 who purchased tickets to the flight 106 in step 205. In various exemplary embodiments, the passengers 102 can check in for the flight 106 according to a variety of methods. These methods can include checking in on the airline's 118 website, at a kiosk at the airport, or with an airline 118 employee at a ticket counter.

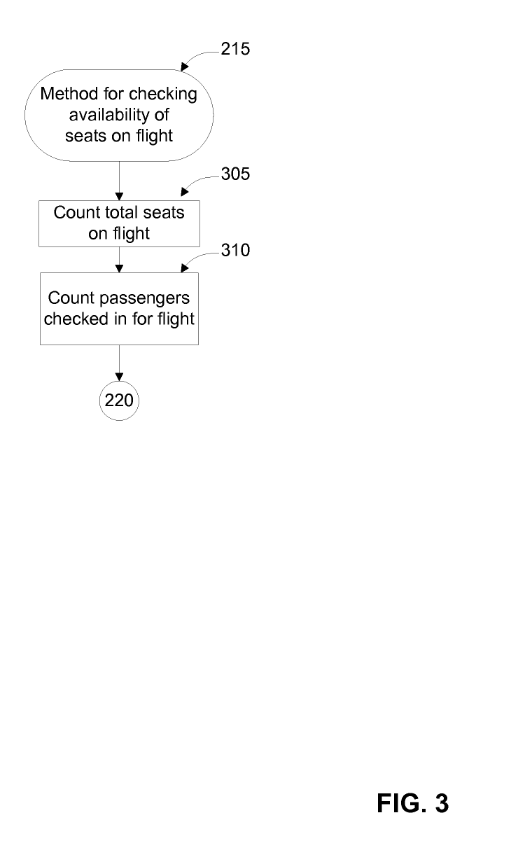

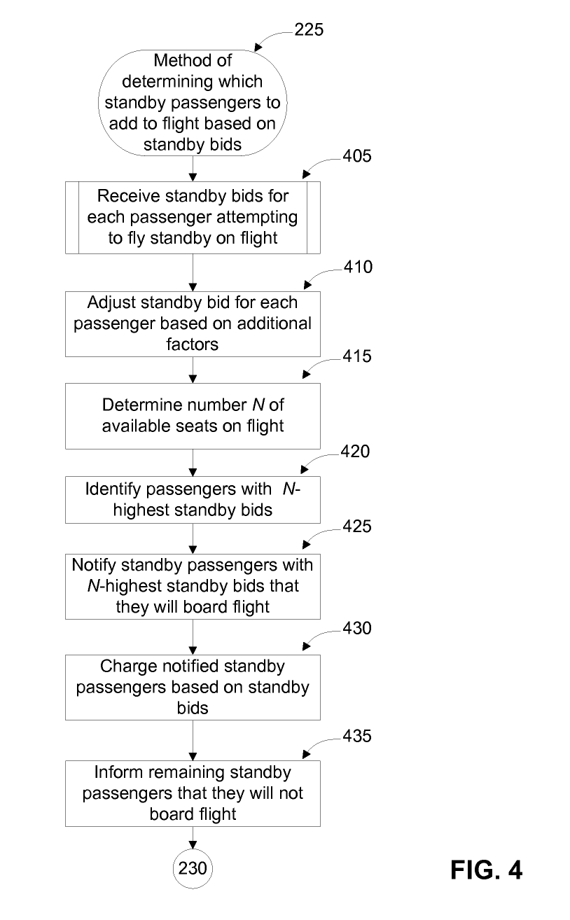

In step 215, the airline 118 checks the availability of seats 104 on the flight 106. Checking the availability of seats 104 can include a comparison of the number of total seats 104 on the flight 106 and the number of passengers 102 who have checked in for the flight 106. Step 215 will be described in more detail with reference to FIG. 3.

In step 220, the airline 118 determines whether the flight 106 is oversold or undersold. In an exemplary embodiment, this determination can be based upon the availability of seats 104 determined in step 215. Thus, if the airline 118 determines that the flight 106B is undersold (i.e., that the number of passengers 102 checked in is less than the number of seats 104 on the flight 106B), the method 200 branches to step 225, where the airline 118 determines which standby passengers 103B to add to the flight 106B based on standby bids 114. However, if the airline 118 determines that the flight 106A is oversold, the method 200 branches to step 235, where the airline 118 determines which ticketed passengers 102A to bump from the flight 106A based on bump bids 110. FIG. 1 depicts an oversold flight 106A and an undersold flight 106B. If the airline 118 determines that the flight 106 is neither oversold nor undersold (i.e., that the number of passengers 102 checked in is equal to the number of seats 104 on the flight 106), then the method 200 branches to step 245, where the airline 118 boards passengers 102 with boarding passes.

In step 225, the airline 118 determines which standby passengers 103B to add to the flight 106B based on standby bids 114. In an exemplary embodiment, this determination can include receiving standby bids 114 from standby passengers 103B, and determining which standby passengers 103B to add to the flight 106B based on those standby bids 114. In an exemplary embodiment, as shown in FIG. 1, the airline 118 can maintain a standby list 108 of passengers 103B seeking to fly standby on the flight 106B.

In one embodiment, all available seats 104B can be assigned to standby passengers 103B based at least in part upon the standby bids 114. In an alternative embodiment, a portion of available seats 104B can be assigned to standby passengers 103B at least in part upon the standby bids 114, and the remainder of the available seats 104B can be assigned to standby passengers 103B by other methods, such as conventional methods or other methods known to one of ordinary skill in the art having the benefit of the present disclosure. Step 225 will be described in more detail with reference to FIG. 4.

In step 230, the airline 118 issues standby boarding passes 116 to the standby passengers 103B added to the flight 106B in step 225. In an exemplary embodiment, the standby boarding passes 116 issued to standby passengers 103B in step 230 can be equivalent to the boarding passes issued to ticketed passengers 102 in step 210, and therefore can entitle the standby passengers 103B with standby boarding passes 116 to a confirmed seat on the flight 106B. In an exemplary embodiment, issuing the standby boarding passes 116 can include printing boarding passes 116 and providing them to the standby passengers 103B. The method 200 then proceeds to step 245, where the airline 118 boards all passengers 102 with boarding passes, including those standby passengers 103B with standby boarding passes 116.

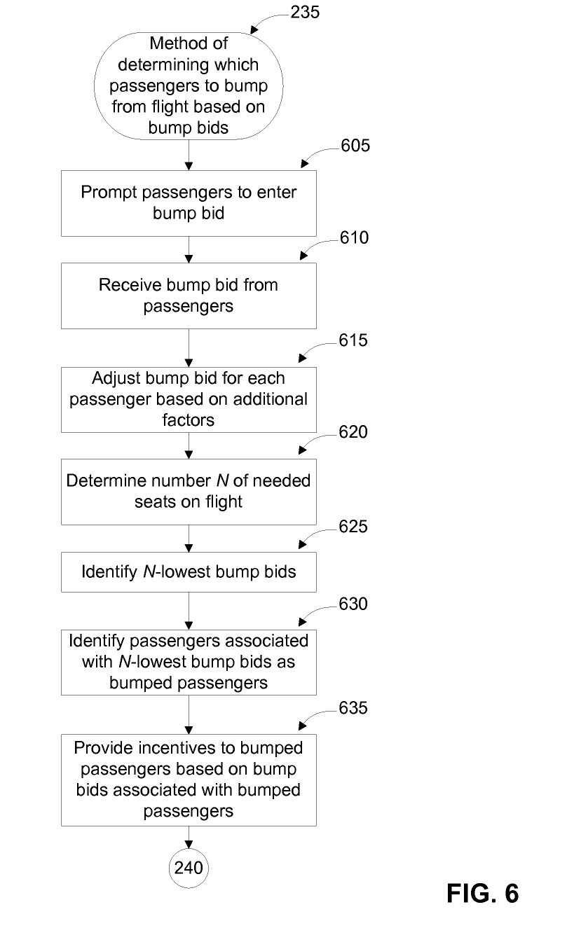

In step 235, the airline 118 determines which ticketed passengers 102A to bump from the flight 106A based on bump bids 110. In an exemplary embodiment, this determination can include receiving bump bids 110 from ticketed passengers 102A, and determining which ticketed passengers 102A to bump from the flight 106A based on those bump bids 110. In one embodiment, as described previously with respect to step 225, all bumped passengers 102A can be selected by the airline 118 based at least in part upon the bump bids 110. In an alternative embodiment, a portion of the bumped passengers 102A can be selected at least in part upon the bump bids 110, and the remainder of the bumped passengers 102A can be selected by other methods, such as conventional methods or other methods known to one of ordinary skill in the art having the benefit of the present disclosure. Step 235 will be described in more detail with reference to FIG. 6.

In step 240, the airline 118 replaces the boarding passes for the passengers 102A that the airline 118 determines to bump in step 235. In an exemplary embodiment, replacing the boarding passes can include taking the boarding pass from the bumped passenger 102A, and issuing (whether printing physical boarding passes 116 or issuing electronic or other non-physical boarding passes 116) a new boarding pass for a different flight 106 to the passenger 102A. The replacement boarding pass can be for a later flight 106 that was selected by the passenger 102A when the passenger 102A submitted its bump bid 110.

In step 245, the airline 118 boards all passengers 102, 103B with boarding passes for the flight 106. In an exemplary embodiment, where the flight 106A was oversold, the passengers 102 boarded on the flight 106A can include all passengers 102A who checked in for the flight 106A in step 210 whom the airline 118 did not bump from the flight 106A in step 235. In another exemplary embodiment, where the flight 106B was undersold, the passengers 102 boarded on the flight 106B can include all passengers 102B who checked in for the flight 106B in step 210, as well as those standby passengers 103B who obtained standby boarding passes 116 in step 230. After the passengers 102, 103B are boarded in step 245, the method 200 ends.

FIG. 3 is a flow chart depicting a method 215 for checking the availability of seats 104 on a flight 106, according to an exemplary embodiment of the invention. In step 305, the total number of seats 104 on the flight 106 are counted. In one embodiment, the total number of seats 104 can be broken down by various sections. For example, the airline 118 can count the total number of first class, business class, and coach class seats 104 separately. In another embodiment, the airline 118 may store data for its airplane flights 106 that track the total number of seats 104 on a given flight 106. Thus, instead of explicitly counting the total seats 104, the total number of seats 104—whether or not broken down by class—can be retrieved from stored data.

In step 310, the number of passengers 102 that have checked in for a flight 106 are counted. In exemplary embodiments, the airline 118 can count the number of passengers 102 that have checked in for the flight 106 at various different times. For example, the airline 118 can count the number of checked-in passengers 102 a fixed amount of time before the flight 106 is scheduled to depart. In an exemplary embodiment, the airline 118 can count the number of checked-in passengers 102 multiple times, or alternatively, the airline 118 can use a server, computer, or other information processing unit to count the number of checked-in passengers 102 continuously. Additionally, as with counting the total number of seats 104 in step 305, the airline 118 count the number of checked-in passengers 102 separately by seat class. The method 215 then returns to step 220, as described previously with reference to FIG. 1.

FIG. 4 is a flow chart depicting a method 225 for determining which standby passengers 103B to add to a flight 106B based on standby bids 114, according to an exemplary embodiment of the invention. In step 405, the airline 118 receives the standby bids 114 for each passenger 103B attempting to fly standby on the flight 106B. In an alternative embodiment, as described previously, the airline 118 may receive standby bids 114 from only a portion of those passengers 103B attempting to fly standby on the flight 106B, as the airline 118 may only seat a portion of the standby passengers 103B according to a standby bid 114, and use other methods for determining which other passengers (not shown) to seat.

In various embodiments, the standby bid 114 received from a passenger 103B can include money or other items. For example, a standby bid 114 of a $50 airline voucher could be submitted. Alternatively, a standby bid 114 can include a number of frequent flier miles. In yet another embodiment, a standby bid 114 could include forfeiting an upgrade. For example, a passenger 103B with a first class ticket on one flight 106 could submit a standby bid 114 by requesting a different flight 106 and being willing to accept a coach or economy class ticket on that flight 106.

In an exemplary embodiment, after receiving the passengers' 103B standby bids 114, the airline 118 can standardize the standby bid 114 values. In other words, the airline 118 can determine the total value associated with receiving each standby bid 114 requested by the passengers 103B. For example, the airline 118 can determine that a standby bid 114 equaling 5,000 frequent flier miles may be worth $25 to the airline 118, while a standby bid 114 of a $100 airline voucher may be worth $75 to the airline 118. Additionally, a $25 standby bid 114 from a first passenger 102A, 103B who has a confirmed ticket on a currently oversold flight 106A (where the airline 118 may need to bump passengers 102A) may be worth more overall to the airline 118 than a $50 standby bid 114 from a second passenger 102B, 103B who has a confirmed ticket on a currently undersold flight 106B. Thus, the particular flight 106 for which the passenger 103B already has a confirmed seat 104B also can affect the airline's 118 valuation of the standby bid 114. In essence, the airline 118 may evaluate the first passenger's 103B standby bid 114 to reflect the fact that the airline 118 will likely have to bump one fewer passenger 102A from the oversold flight 106A if the first passenger's 103B standby bid 114 is accepted. In one embodiment, the airline 118 can utilize a computer program or database that estimates or calculates the value of each bump bid 114 (including the value and form of the bid 114 and the passenger's 103B original flight 106) received from a passenger 103B.

The set of passengers 103B that are seeking to fly standby on a given flight 106B can be determined by a variety of methods. Regardless of the method or methods used to determine the passengers 103B seeking to fly standby, the identity of the passengers 103B can be maintained on a standby list 108. The standby list 108 can be stored in a database that also stores a corresponding standby bid 114 for each passenger 103B on the standby list 108.

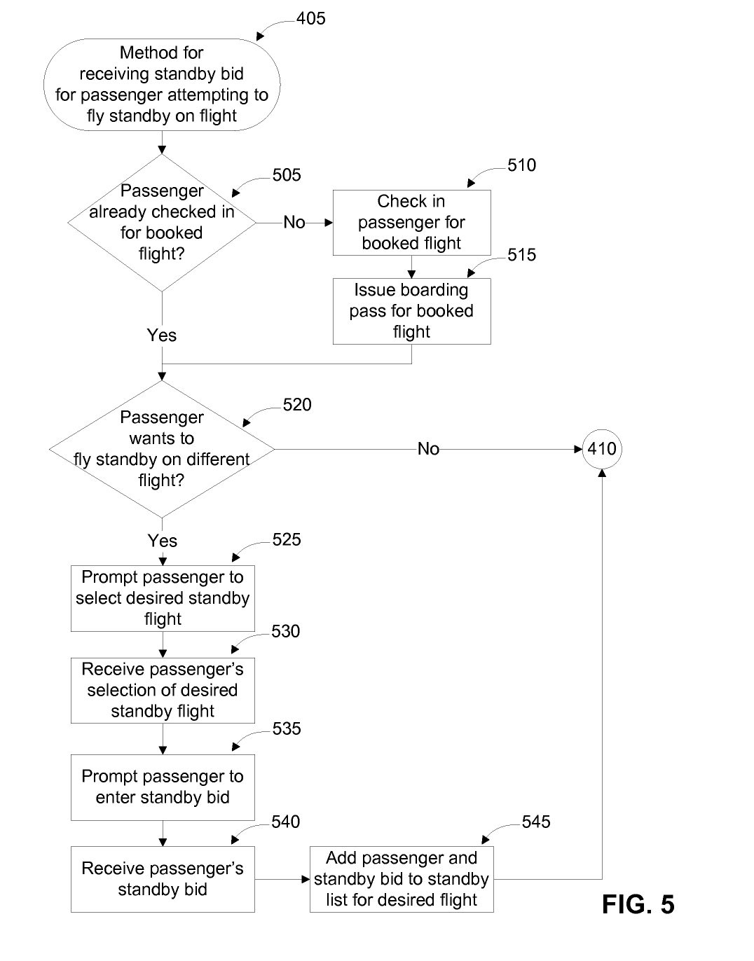

In certain embodiments, some standby passengers 103B may be traveling in groups, such as a family. In such cases, the group of passengers 103B may submit the same bid for each passenger 103B in the group. Alternatively, the group may submit one bid for the entire group of passengers 103B, in which case the airline 118, after receiving the bid, can divide the bid by the number of passengers 103B in the group so that the airline 118 can compare the bid to other bids received from individual passengers 103B. Additionally, a group of passengers 103B can indicate whether the group would be willing to travel even if they could not be seated together on the flight 106B. Various methods can be used for identifying whether standby passengers 103B are traveling together in a group. For example, standby passengers 103B with tickets under the same reservation or confirmation number can be treated as a group. Additional methods include standby passengers 103B with the same contact address or phone number or those having tickets purchased with the same credit card. Additionally, standby passengers 103B can be invited to identify other passengers 103B traveling in their group, such as when checking in for a flight 106 or when entering a standby bid 114. Step 405 will be described in more detail with reference to FIG. 5.

In step 410, the standby bid 114 received by each passenger 103B can be adjusted based on additional factors. In exemplary embodiments, a variety of additional factors can be used to adjust the standby bid 114 received by each passenger 103B in step 405. In one embodiment, the airline 118 can adjust a standby bid 114 entered by a passenger 103B based on the fare class of the passenger's 103B ticket. For example, if a passenger 103B purchased a full fare ticket rather than a discounted ticket, the passenger's 103B standby bid 114 may be increased by a certain percentage (e.g., 10%) or amount (e.g., $50). The increase in the bid need not affect the actual amount the passenger 103B would pay for the standby seat 104B if the passenger's 103B bid is eventually accepted. Rather, the increase in the bid can be an adjustment made by the airline 118 to provide a benefit to passengers 103B who pay for full fare tickets instead of discounted tickets.

Another factor that can be used to adjust a passenger's 103B bid is the frequent flier status of the passenger 103B. Many airlines 118 offer frequent flier programs to reward those passengers 102, 103B who repeatedly travel with the airline 118 or its partners. Some airlines 118 further provide different tiers of frequent flier status, such as providing a first level for occasional travelers, a second level for those traveling at an intermediate frequency, and a third level for those that travel very regularly. Thus, in one embodiment, an airline 118 can adjust a passenger's 103B bid based on the passenger's 103B status at a frequent flier, and the particular level of frequent flier status. For example, the bid of an occasional traveler who participates in an airline's 118 frequent flier program can be increased by a certain small percentage (e.g., 5%), while bids of intermediate and very regular travelers can be increased by greater percentages (e.g., 15% and 25%, respectively).

In another embodiment, the airline 118 can offer passengers 103B an option to pay a fee in advance in exchange for increasing their standby bid 114 by a given percentage, should the passenger 103B later attempt to fly standby. For example, an airline's 118 website that allows passengers 103B to purchase tickets on-line can include such an option during the purchasing process for passengers 103B. The same or similar options can be offered to a passenger 103B during the purchasing process—or at a different time—regardless of the purchasing method (e.g., kiosks, in-person, over the telephone) used. In a particular embodiment, an airline 118 can offer the passenger 103B the option to pay a variety of fees in exchange for increasing their standby bid 114 by a corresponding variety of amounts in the event the passenger 103B eventually seeks to exchange the seat 104 on the ticketed flight 106 to fly standby on a different flight 106B. For example, the airline 118 can offer the passenger 103B the option of paying an extra $10.00, $25.00, or $50.00 in return for increasing the passenger's 103B bid by 10%, 25%, or 50% respectively, in the event the passenger 103B submits a standby bid 114 for one or more flights 106B.

In another embodiment, the airline 118 can offer the passenger 103B the option to pay a one-time or recurring fee to increase all standby bids 114 the passenger 103B submits over a given time period. For example, the airline 118 can offer passengers 103B the option to pay a $100 fee in exchange for increasing the passenger's 103B standby fee by a fixed percentage for a one-year period.

In yet another embodiment, an airline 118 can adjust the standby bid 114 of a passenger 103B if the passenger 103B is seeking to fly standby on a flight 106B because the flight 106 for which the passenger 103B was ticketed was canceled by the airline 118, or if the passenger 103B missed the ticketed flight 106 due to a late connecting flight 106. Additionally, an airline 118 can adjust the standby bid 114 based on how long the passenger 103B has been attempting to board a standby flight 106B, whether in terms of the amount of time or in terms of the number of flights 106B on which the passenger 103B has attempted to fly standby.

In various other embodiments, a variety of behaviors that the airline 118 seeks to encourage can lead to an increase in a passenger's 103B bid. For example, an airline 118 can increase a standby bid 114 for a passenger 103B who purchased a ticket far in advance of the flight 106. Similarly, an airline 118 can increase a standby bid 114 for a passenger 103B who does not have check-in baggage, or alternatively, carry-on baggage. Other additional factors that can be used to adjust a standby bid 114, including those based on behaviors that the airline 118 may want to encourage, can be determined by one of ordinary skill in the art having the benefit of the present disclosure.

Additionally, although each of the foregoing examples for adjusting a standby bid 114 relate to increasing the bid, decreasing a bid under reverse circumstances (e.g., decreasing a bid for purchasing a discounted ticket) is also possible. However, given that the standby bids 114 may be adjusted only internally to help the airline 118 organize the list 108 of standby passengers 103B, rather than the actual standby bids 114 that the standby passengers 103B would pay being affected, decreasing the bids instead of increasing them may not have any practical effect.

Moreover, the airline 118 can determine whether or not to indicate to the passenger 103B the “adjusted” value of the passenger's 103B standby bid 114. In one embodiment, the airline 118 may determine that providing the adjusted value of the standby bid 114 to the passenger 103B can allow passengers 103B to submit a well informed bid, and therefore choose to provide this information. Alternatively, the airline 118 may believe that providing the adjusted value of the standby bid 114 to the passenger 103B may prevent the passenger 103B from entering the maximum value that the passenger 103B would be willing to pay, and therefore decline to provide this information.

In step 415, a number N corresponding to the number of available seats 104B on the flight 106B is determined. This can be accomplished by subtracting the number of checked-in passengers 102 from the total number of seats 104 on the flight 106B. In an exemplary embodiment, different flight classes (e.g., first, business, and coach) can have a separate corresponding number N, and as such, the bidding process and seating process for standby passengers 103B can be performed separately by flight class.

In step 420, the N-highest standby bids 114 are identified. In an exemplary embodiment, the N-highest bids can be identified based on the values for the bids as adjusted in step 410. Identifying the N-highest bids can include sorting all bids received by the airline 118 in descending order, selecting the highest bid, and then continuing to select each next highest bid until N bids have been selected.

In an exemplary embodiment, the airline 118 can take into account groups traveling standby together in identifying the N-highest bids. For example, if there are five available seats 104B (i.e., N=5), and the two highest bidders have been identified so only three seats 104B are available, a family of four passengers 103B each having the next highest bid may not be identified as the next highest bidders, since there are not sufficient seats for all members of the family. Then, an individual passenger 103B (or smaller group of passengers 103B) with the next highest bid after the family's bid can be identified. In an alternative embodiment, a family or other group in such a position can indicate whether a subset of the family or group is willing to board the flight 106B. In another embodiment, when groups are traveling together, the airline 118 can skip over a higher bidding single passenger 103B for a groups of passengers 103B traveling together, if more financially efficient for the airline 118. For example, if there are three remaining seats 104B on a flight 106, and the highest remaining standby bid 114 is $200 for one passenger 103B, followed by $100 each for a group of three standby passengers 103B traveling together, with one remaining bid 114 of $50 for one standby passenger 103B, the airline 118 can determine that the revenue generated by selecting the three standby passengers 103B traveling together ($300) would exceed the revenue if the airline 118 selected the highest bidding passenger 103B ($200) and the remaining passenger 103B ($50). Thus, in such a case, the airline 118 may skip over the highest bidding passenger 103B to maximize the total revenue generated from standby bids 114.

In step 425, the standby passengers 103B with the N-highest bids (i.e., those passengers 103B identified in step 420) are notified that they may board the flight 106B. In exemplary embodiments, these passengers 103B can be informed via an audio and/or video announcement that they have been selected to board the flight 106B.

In step 430, the standby passengers 103B notified in step 425 are charged an amount equal to their standby bid 114. As described previously, the amount charged may not be the adjusted standby bid 114 determined in step 410, but rather the standby bid 114 received by the airline 118 in step 405. In an exemplary embodiment, the notified passengers 103B can provide a credit card or other form of payment to the airline 118 to pay for their standby bids 114 after they are notified of their selection. In an alternative embodiment, passengers 103B can provide a credit card or other form of payment to the airline 118 when they submit their standby bids 114, and then the airline 118 can charge the credit card only if and when their standby bids 114 are selected. In yet another embodiment, the airline 118 can charge a credit card that the passenger 103B originally used to purchase the ticket for the flight 106B to pay for the standby bid 114.

In step 435, the airline 118 notifies the remaining standby passengers 103B (i.e., those that were not notified in step 425) that they will not board the flight 106B. These passengers 103B may not be charged by the airline 118. In one embodiment, these passengers 103B can be automatically transferred to the standby list 108 for the next flight 106 to the same destination. In a particular embodiment, the standby bids 114 for each of these passengers 103B that were received by the airline 118 in step 405 also can be transferred to the next flight's 106 standby list 108. In an alternative embodiment, these passengers 103B can be given the opportunity to enter a new standby bid 114 for the new flight 106B. After step 435, the method 225 proceeds to step 230, as referenced in FIG. 2.

FIG. 5 is a flow chart depicting a method 405 for receiving a standby bid 114 for a passenger 103B seeking to fly standby on a flight 106B, according to an exemplary embodiment of the invention. In step 505, the method 405 determines whether the passenger 103B has already checked in for the passenger's 103B booked flight 106. The booked flight 106 can refer any flight 106 for which the passenger 103B has a confirmed seat 104, ticket, or boarding pass. If the passenger 103B has already checked in, the method 405 branches to step 510. If the passenger 103B has not already checked in, then the method 405 branches to step 520. In an alternative embodiment, the passenger 103B seeking to fly standby on a flight 106B may not already have a confirmed seat 104, ticket, or boarding pass for a given flight 106. For example, an airline 118 can have a policy or promotion that allows certain passengers 103B to fly standby without having a confirmed seat 104. In such an embodiment, the method 405 can proceed directly to step 525, where the passenger 103B is prompted to select the desired standby flight 106B.

In step 510, the passenger 103B is checked in for the booked flight 106. Various methods exist for checking in a passenger 103B for a flight 106. Passengers 103B can be checked in, for example, via the airline's 118 website, via a kiosk, or in person at a ticket counter. Other suitable methods of checking in passengers 103B can be used as well.

In step 515, a boarding pass is issued to the passenger 103B. The boarding pass can correspond to the flight 106 for which the passenger 103B checked in during step 510. In an exemplary embodiment, once a boarding pass is issued to a passenger 103B in step 515, the airline 118 can update its count of checked-in passengers 103B and available seats 104 as described previously with reference to step 215. The method 405 then proceeds to step 520.

In step 520, the method 405 determines whether a passenger 103B wants to fly standby on a different flight 106B (i.e., a flight 106B other than the one for which the passenger 103B has checked in). If the passenger 103B wants to fly standby on a different flight 106B, the method 405 branches to step 525. Otherwise, the method 405 proceeds to step 410, as referenced in FIG. 4.

In various embodiments, the passenger 103B can indicate a desire to fly standby on a different flight 106B in a variety of ways. For example, the passenger 103B can use the airline's 118 website to indicate a desire to fly standby on another flight 106B. Alternatively, the passenger 103B can use a kiosk at the airport, or indicate to an airline 118 employee—whether at a ticket counter, or to an employee at the departure gate for the desired standby flight 106B—that the passenger 103B would like to be added to a standby list 108 for a different flight 106B.

In an alternative embodiment, the airline 118 can determine whether a passenger 103B wants to fly standby before the passenger 103B has checked in for a flight 106, or during the check-in process. For example, in one embodiment, a passenger 103B can check in for a flight 106 using the airline's 118 website or an airline 118 kiosk, and during the check-in process, the passenger 103B can be prompted to indicate whether the passenger 103B wants to be added to the standby list 108 for a given flight 106B. In another embodiment, the standby bid 114 can be received from a passenger 103B well before (i.e., hours or days before) the passenger 103B checks in. For example, a passenger 103B may realize days in advance of a scheduled flight 106 that another flight 106 would be preferable. Additionally, a passenger 103B may also submit as part of a standby bid 114 a time window during which the passenger's 103B standby bid 114 is valid. For example, a passenger 103B submitting a standby bid 114 several days in advance of the flight 106 may have the standby bid 114 expire within two hours of the departure time of the flight 106 for which the standby bid 114 was submitted. In essence, the passenger 103B may not want to arrive at the airport early in hopes of getting on the standby flight 106, not be selected, and then remain at the airport for several hours until the original flight 106 departs.

In step 525, the passenger 103B is prompted to select the desired standby flight 106B. In one embodiment, the passenger 103B can be prompted to enter this selection immediately after indicating a desire to fly standby. Additionally, to facilitate the passenger's 103B entry of this selection, the airline 118 can provide to the passenger 103B a list of flights 106 to the passenger's 103B desired destination. Such a list can include only those flights 106B where there is at least one seat 104B available. Then, in step 530, the passenger's 103B selection of the desired standby flight 106B is received by the airline 118.

In step 535, the passenger 103B is prompted to enter a standby bid 114. The standby bid 114 can represent the maximum amount that the passenger 103B is willing to pay to be able to fly on the desired flight 106B. In one embodiment, the passenger 103B can be prompted to enter this selection immediately after selecting the desired standby flight 106B in step 525. Then, in step 540, the passenger's 103B entry of the standby bid 114 is received by the airline 118.

The steps 520 through 535 can be performed in a variety of ways and by utilizing a variety of interfaces. Additionally, the steps can be performed at a variety of times—such as during the check-in process, or after the check-in process. For example, in some embodiments, where the passenger 103B checks in for a ticketed flight 106 using the airline's 118 website or kiosk, the airline 118 can perform steps 520 through 535 using the website or kiosk.

Alternatively, where the airline 118 performs steps 520 through 535 after the check-in process, the airline 118 can provide a separate website interface or kiosk for interfacing with the passenger 103B. An exemplary kiosk can be located at or near the departure gate for each flight 106. Additionally, an exemplary website interface for interacting with a passenger 103B in performing steps 520 through 535 can be specially configured for mobile or handheld Internet devices. Thus, passengers 103B who have already checked in for a flight 106, and may be seated in an airport terminal near the departure gate for another flight 106B on which they may desire to fly standby can use a mobile Internet device to access the airline's 118 website, which can receive a passenger's 103B indication of a desire to fly standby on a particular flight 106B, as well as the passenger's 103B standby bid 114 for the flight 106B.

In another embodiment, the airline 118 can provide an interface with a passenger 103B for performing steps 520 through 535 via electronic mail, text messaging, or other similar messaging interface. For example, a passenger 103B can send an email or text message to a specific address that includes information that can allow the airline 118 to perform steps 520 through 535. In an exemplary embodiment, a passenger 103B can send an email or text message to an address provided by the airline 118 that indicates the desired flight 106B and the passenger's 103B standby bid 114 for the flight 106B. In one embodiment, the message also can include an identification of the passenger 103B, such as the passenger's 103B ticket number or confirmation number. Alternatively, the identification of the passenger 103B can include the telephone number or email address from which the passenger 103B sent the message. If the passenger 103B is part of a family or group, as described previously, the passenger's 103B message can include an identification of the other passengers 103B within the group, as well as an indication of whether the group is willing to fly without sitting next to each other. Other interfaces for interacting with a passenger 103B in performing steps 520 through 535, such as an automated telephone system, may be recognized by one of ordinary skill in the art and can be utilized as appropriate. Additionally, an airline 118 can utilize a combination of two or more of the foregoing interfaces to perform steps 520 through 535.

Regardless of the interfaces used by the airline 118 to perform steps 520 through 535, the airline 118 can choose the amount of information regarding the standby list 108 to share with passengers 103B seeking to fly standby on a given flight 106B. For example, the airline 118 can announce the number of available seats 104B on a flight 106B to passengers 103B within proximity of the flight's 106B departure gate. For flights 106B on which only a few seats 104B are available, providing such information may encourage passengers 103B to enter a high bid to improve their chances of securing a seat 104B on the flight 106B. Alternatively, especially in cases where there may be many available seats 104B on a fight, the airline 118 may not share the number of available seats 104B with potential passengers 103B, because such information may encourage passengers 103B to enter a lower standby bid 114 than they would truly be willing to spend to board the flight 106B.

Additionally, the airline 118 can choose to keep all passengers' 103B bids hidden from other passengers 103B. Not sharing this information also can encourage passengers 103B to enter a standby bid 114 equal to the maximum amount they are willing to spend, rather than entering a standby bid 114 minimally above another passenger's 103B standby bid 114. Alternatively, if the airline 118 believes that sharing passengers' 103B bids with other passengers 103B may increase competitive bidding between passengers 103B, thereby driving standby bids 114 upward, the airline 118 can display (or otherwise provide to passengers 103B) a list of the top passengers' 103B standby bids 114 to other passengers 103B. In other embodiments, the airline 118 can also decide whether to provide various other information to standby passengers 103B, or whether to keep that information inaccessible to standby passengers 103B. Such information can include, for example, the number of checked-in passengers 102, the number of seats 104B likely to be available for standby passengers 103B, the names of standby passengers 103B, and the like.

Moreover, the airline 118 also can choose whether to allow passengers 103B to submit only one standby bid 114, or instead, to allow passengers 103B to edit or adjust the standby bid 114, or to submit a subsequent standby bid 114. In one embodiment, the airline 118 can permit passengers 103B only to submit one standby bid 114 per flight 106B. This can encourage passengers 103B to submit their true, maximum standby bid 114, rather than to attempt to enter a lower bid with hopes of increasing the standby bid 114 should the passenger 103B later receive more information (such as learning that the flight 106B is nearly full) that suggests it may be difficult to receive a seat 104B on the flight 106B with a low standby bid 114.

In step 545, the passenger 103B and the passenger's 103B standby bid 114 are added to the standby list 108 for the desired flight 106B. After step 545, the method 405 proceeds to step 410, as referenced in FIG. 4.

FIG. 6 is a flow chart depicting a method 235 for determining which passengers 102A to bump from a flight 106A based on bump bids 110, according to an exemplary embodiment of the invention. In step 605, the passengers 102A are prompted to enter a bump bid 110. In exemplary embodiments, the airline 118 can prompt passengers 102A to enter a bump bid 110 in a variety of ways. In one embodiment, the airline 118 can prompt passengers 102A by announcing (whether via an audio announcement, a video display, or other means) that the flight 106A has been oversold, and that any passengers 102A that have boarding passes or confirmed seats 104A on the flight 106A that are willing to be bumped from the flight 106A and instead board a later replacement flight 106 can submit a bump bid 110.

The bump bid 110 submitted by the passengers 102A can include a desired incentive 112 representing what each passenger 102A would be willing to accept in exchange for being bumped from the flight 106A. In one embodiment, the bump bid 110 can include the amount of money that the passenger 102A would be willing to accept. The amount of money can be in the form of a cash payment or an airline 118 voucher. In another embodiment, the bump bid 110 can include a number of frequent flier miles—or other non-monetary incentives 112—that would be added to the passenger's 102A account in exchange for being bumped from the flight 106A. In yet another embodiment, the bump bid 110 can include an offer to be bumped from the flight 106A in exchange for receiving an upgrade to another flight class (e.g., first class) on the passenger's 102A replacement flight 106.

Moreover, the bump bid 110 submitted by any passenger 102A can include a combination of one or more types of desired incentives 112. An exemplary bump bid 110 thus can include a monetary incentive 112, a request for frequent flier miles, and a request for a class upgrade on a replacement flight 106. In another embodiment, a passenger can submit multiple bump bids, such as bump bids with different types of incentives. For example, a passenger can submit a bump bid of $100 in cash, as well as an alternative bid of 10,000 frequent flier miles. Incentives 112 also can include a request for a hotel room, food vouchers, or other incentives that may be recognized by one of ordinary skill in the art having benefit of the present disclosure.

In one embodiment, the bump bids 110 can specify a particular incentive 112, and the bumped passengers 102A can be bumped to a replacement flight 106, such as the next flight 106 to the same destination, or another flight to the same or similar destination specified by the airline 118. Alternatively, the airline 118 could specify multiple replacement flights 106, from which the passenger 102A can select one or more and submit incentives 112. In another embodiment, the bump bids 110 can specify, along with the desired incentive 112, the desired replacement flight 106, or a description of acceptable flights (e.g., flights within a given time period, such as within a time period of the originally scheduled flight).

In another embodiment, bump bid 110 can be received from a passenger 102A well before (i.e., hours or days before) the passenger 102A checks in, or even at the time of purchasing the ticket for the flight 106. For example, a passenger 102A may realize days in advance of a scheduled flight 106 that the passenger's 102A schedule is flexible and that the passenger 102A would be willing to be bumped from the flight 106. Additionally, a passenger 102A may also submit as part of a bump bid 110 a time window during which the passenger's 102A bump bid 110 is valid. For example, a passenger 102A submitting a bump bid 110 several days in advance of the flight 106 may have the bump bid 110 expire within two hours of the departure time of the scheduled flight 106. In essence, the passenger 102A may be willing to be bumped from a flight 106 before the passenger 102A leaves home for the originally scheduled flight 106, but may not want to be bumped once the passenger 102A has left for the airport. In an alternative embodiment, the bump bid 110 window (or conversely, the standby bid 114 window described above) can be based on location, instead of time. For example, the bump bid 110 or standby bid 114 can be set to expire when the passenger's 102A location indicates that the passenger 102A is within a given range of the airport. Various exemplary methods for identifying and/or receiving the location of the passengers 102 are discussed in more detail below.

Additionally, as discussed above with reference to standby bids 114, the airline 118 can choose whether or not to make accessible various information to passengers 102A submitting bump bids 110. Such information can include, for example, the number of checked in passengers 102A, the number of seats 104A by which the flight 106 is likely oversold (i.e., number of seats 104A needed), the number of passengers 102A already having submitted bump bids 110, the bump bids 110 of other passengers 102A, the names of passengers 102A having submitted bids 110, and the like.

In step 610, the bump bids 110 the passengers 102A entered in step 605 are received. In an exemplary embodiment, after receiving the passengers' 102A bump bids 110, the airline 118 can standardize the bump bid 110 values. In other words, the airline 118 can determine the cost associated with providing each incentive 112 requested by the passengers' 102A bump bids 110. For example, the airline 118 can determine that a bump bid 110 that includes a request for 5,000 frequent flier miles can cost $150 to the airline 118, while a bump bid that includes a request for a $175 airline voucher can cost the airline 118 only $140. Similarly, the airline 118 can determine that seating a bumped passenger 102A on a popular replacement flight 106 may cost the airline 118 more than seating a bumped passenger 102A on a less popular flight 106. Additionally, the airline 118 can determine that the cost associated with bumping a passenger 102A who has a connecting flight 106 can be higher or lower, depending on the overbooked or underbooked status of the connecting flight 106. Thus, the particular replacement flight 106 selected by the passenger 102A also can affect the airline's 118 cost calculation and standardization. In one embodiment, the airline 118 can utilize a computer program or database that estimates or calculates the cost of each bump bid 110 (including the incentive 112 and the replacement flight 106) received from a passenger 102A.

In step 615, each passenger's 102A bump bid 110 is adjusted based on additional factors. As described previously with respect to adjusting standby bids 114 with reference to step 410 of FIG. 4, the airline 118 can use a variety of additional factors to adjust the bump bids 110. In various embodiments, the airline 118 can adjust bump bids 110—such as by decreasing the value of the bump bids 110—based on the fare class of the passenger's 102A ticket, the passenger's 102A frequent flier status, whether the passenger 102A has paid a one-time or recurring fee in return for having the bump bid 110 adjusted, or any other suitable factor. As described previously with reference to adjusting standby bids 114, the adjustment of the bump bids 110 may not affect the amount or type of the incentive 112 that the passenger 102A will actually receive if the passenger's 102A bump bid 110 is accepted. Rather, the adjustment may affect only how the passenger's 102A bump bid 110 is compared to other passenger's 102A bump bids 110.

In step 620, a number N corresponding to the number of needed seats 104A on the flight 106A is determined. This can be accomplished by subtracting the total number of seats 104A on the flight 106A from the number of checked-in passengers 102A.

In step 625, the N-lowest bump bids 110 are identified. In an exemplary embodiment, the N-lowest bump bids 110 can be identified based on the values for the bids as standardized, and then adjusted in step 615. Identifying the N-lowest bids can include sorting all bump bids 110 received by the airline 118 in ascending order, selecting the lowest bid, and then continuing to select each next lowest bid until N bids have been selected. As described previously with reference to standby bids 114, the airline 118 can identify groups traveling together and take into account groups traveling together who submit bump bids 110. For example, if only three seats 104A are needed on a flight 106A, and a four-person family has submitted the lowest bump bid 110, the airline 118 can skip over that family and move to the next lowest bump bids 110. Alternatively, if the airline 118 determines that the four-person family's bid is so much lower than the next lowest bump bid 110 that the airline 118 would lose less revenue by paying the incentives 112 to the four-person family than by bumping three individual passengers 102A, the airline 118 can bump the four-person family and have an empty seat 104A. In a particular embodiment, the airline 118 then can fill the empty seat 104A with a standby passenger 103B, such as the standby passenger 103B with the highest standby bid 114.

In step 630, the passengers 102A with the N-lowest bids (i.e., the passengers 102A with the bump bids 110 identified in step 625) are notified that their bump bids 110 have been accepted and that they have been bumped from the flight 106A. In exemplary embodiments, these passengers 102A can be informed via an audio and/or video announcement that they have been bumped from the flight 106A.

In step 635, the passengers 102A notified in step 630 are provided with incentives 112 based on their bump bids 110. In an exemplary embodiment, the incentives 112 can be provided immediately, such as by crediting a cash reward to a credit card or other electronic account associated with the passenger 102A. If frequent flier miles or airline 118 vouchers are provided as part of the incentive 112, then those incentives 112 can be added to the passenger's frequent flier account with the airline 118.

After step 635, the method 235 returns to step 240.

Although much of the foregoing disclosure describes exemplary embodiments for, among other things, identifying standby passengers 103B to board an undersold flight 106B based on standby bids 114, and identifying passengers 102A to bump from an oversold flight 106A based on bump bids 110, in alternative embodiments the two types of analyses can be combined. In other words, as briefly referenced above with reference to bump bidding, an airline 118 can choose to receive both standby bids 114 and bump bids 110 for the same flight 106. When both bump bids 110 and standby bids 114 are received for a given flight 106, the airline 118 in certain embodiments may want to bump certain passengers 102A from the flight 106 in order to allow certain standby passengers 103B to board the flight 106. For example, if there is a flight 106 that is neither oversold nor undersold, and there is one standby passenger 103B who submitted a standby bid 114 of $100 and a passenger 102A with a confirmed seat 104A that submitted a bump bid 110 of $50, the airline 118 may choose to accept both passengers' 102A, 103B bids 110, 114. In other words, the airline 118 can pay the passenger 102A with a confirmed seat 104A $50 to be bumped from the flight 106, and accept the standby bid 114 of $100 for the standby passenger 103B to board the flight 106.

Additionally, as discussed above, standby bids 114 and bump bids 110 may be submitted hours or days in advance of the flights' 106 scheduled departure time. Thus, in certain embodiments, if an airline 118 has received a standby bid 114 for a flight 106 that exceeds a bump bid 110 submitted for the same flight 106, the airline 118 may choose to notify both passengers 102A, 103B that the bids 110, 114 have been accepted hours or days before the scheduled departure time. Thus, in such embodiments, both passengers 102A, 103B can know in advance that their bids 110, 114 to change flights 106 have been accepted, and can adjust their departure for the airport accordingly. Alternatively, the airline 118 can wait until closer to the departure time in hopes of obtaining more bump and standby bids 110, 114 (and possibly higher standby bids 114 and lower bump bids 110) and thus improve its profit.

In another additional exemplary embodiment, airlines 118 can communicate offers or counter-offers to incentives submitted as bump bids 110 to encourage passengers 102A to volunteer to be bumped from their flights 106. In certain embodiments, the airline 118 may need to bump passengers 102A from an oversold flight 106A, but may not be willing to pay the incentives submitted by the passengers 102A submitting bump bids 110. In such an embodiment, the airline 118 can communicate counter-offers to the passengers 102A submitting bump bids 110. For example, if a given flight 106A is oversold by one passenger 102A, but the lowest bump bid 110 received is $500 (which the airline 118 may consider too high, as it may exceed the penalty the airline 118 would have to pay for involuntarily bumping a passenger 102A), the airline 118 may transmit a counter-offer of—for example—$300 in cash to one or more passengers 102A who had submitted bump bids 110. This may be successful as certain passengers 102A may have submitted a bump bid 110 higher than what they would have truly accepted to be bumped from the flight 106 in hopes of obtaining a higher incentive, and other passengers' 102A circumstances may have changed since submitting their bump bids 110 and would be willing to be bumped for a lower incentive.

The same principle can be applied to counter-offers to standby bids 114. For example, if a flight 106B has many open seats 104B, but the highest standby bid 114 received is very small (e.g., $5), the airline 118 may transmit a counter-offer of—for example—$25 to one or more passengers 103B who had submitted standby bids 114.

As discussed above, passengers 102, 103 can submit their bump bids 110 or standby bids 114 to airlines 118 via a mobile Internet device—whether by email, text message, or an Internet website. In exemplary embodiments, the mobile Internet device (e.g., a smartphone) can run a web-based application or include an application specifically for interacting with one or more airlines 118 (e.g., purchasing tickets, checking in for flights 106, displaying boarding passes 116, receiving new boarding passes 116 when the passenger 102 changes flights 106, submitting standby bids 114 and/or bump bids 110, etc.). In additional exemplary embodiments, the mobile Internet device can include a location module (such as a GPS or a processor capable of identifying location by triangulating or analyzing mobile signals) that can identify the location of the device and therefore the passenger 102, and can communicate that location to the airline 118. In certain embodiments, the passenger 102 may need to authorize the airline 118 to be able to identify the passenger's 102 location, whether on a case-by-case or permanent basis. The airline 118 may further offer some type of reward or incentive to passengers 102 in exchange for allowing the airline 118 to receive the location of the passengers 102. In certain embodiments, the location of the passenger's 102 mobile Internet device may only report its location after the passenger 102 has checked in for a flight 106, within a given time of the passenger's 102 flight's 106 departure, or when the location of the device is within a given range of the passenger's 102 departing airport. Other methods of the airline 118 receiving the location of passengers 102 also can be used, such as receiving a GPS or triangulation signal from a conventional mobile phone, receiving a location based on the use of the Internet through a WiFi/WiMax signal, proximity to a bluetooth, RFID, Near-Field Communication sensor, or the like.

Once the airline 118 has received the location of the passenger 102, the airline 118 then can use the location of the passengers 102 to identify passengers 102 to whom to transmit counter-offers for standby or bump bids 110, 114. For example, a passenger 102 who submitted a bump bid 110 of $200 but has not reached the departing airport yet (and perhaps still located at or near the passenger's 102 home address or hotel address) may be more willing to accept a lower incentive (e.g., $150) than a passenger 102 who submitted a bump bid 110 of $180 but is already located at the airport. Similarly, a passenger 102 who submitted a standby bid 114 of $50 and has already reached the airport may be more willing to accept a higher standby counter-offer (e.g., $65) than a passenger 102 who submitted a standby bid 114 of $60 but is still far away from the airport.

In addition to the bid 110, 114 and location of the passenger 102, other factors can be used to estimate a passenger's 102 valuation of a seat 104 on a flight 106, and therefore to determine to whom to provide counter-offers and/or how to determine a counter-offer for a given passenger 102. For example, valuation can also be estimated by factors such as fare class, length of reservation, whether the reservation includes a weekend, or other factors may indicate that the passenger 102 is traveling for leisure. Such passengers 102 may be more willing to accept a lower bump bid 110 counter-offer than passengers 102 who paid a higher fare class and who will be returning home within one day. Additionally, airlines 118 can prompt passengers 102 to describe the nature of their trip when purchasing tickets, checking in, or any other time, and can then use this information to determine passengers' 102 likelihood for accepting relatively low bump bids 110 or relatively high standby bids 114.

In another exemplary embodiment, an airline 118 can contact passengers 102 as described above with standby or bump offers without first receiving standby bids 114 or bump bids 110 from passengers 102. For example, if the airline 118 knows several hours or days in advance that a given flight 106 is likely to be oversold, the airline 118 may contact (e.g., via email, text message, an Internet interface, a smartphone application, or the like) some or all of the passengers 102 with incentives to be bumped from their flight 106, such as when or shortly after the passenger 102 checks in for the flight 106. Additionally, or alternatively, the airline 118 can also identify the location of various passengers 102 (e.g., checked-in passengers 102) and identify those passengers 102 who are at or near their home address and/or far away from the departing airport. The airline 118 then can offer relatively low bump incentives to these passengers 102.

Similarly, if an airline 118 knows in advance that a given flight 106 is likely to be undersold, the airline 118 may contact some or all of the airline's 118 passengers 102 on other flights 106 to the same destination as the undersold flight 106B with an offer to change their flight 106 to the undersold flight 106B for a relatively low fee (or even free). Additionally, or alternatively, the airline 118 can also identify the location of various passengers 102 and identify those passengers 102 who are at or near the airport already, and offer a fee to change their flight 106 to the undersold flight 106B, as the passengers 102 at or near the airport may be most likely to be willing to pay a small fee to change their flight 106 to the undersold flight 106B. Alternatively, particularly if the undersold flight 106B departs after the passenger's 102 current flight 106, the airline 118 can identify those passengers 102 who are still near their home address and/or far away from the airport and offer them a chance to change their flight 106 to the undersold flight 106B for a fee, as those passengers 102 may be most likely to be willing to delay their flight 106 (as opposed to passengers 102 who are already near the airport for their regularly scheduled flight 106). Additionally, if the airline 118 determines that a passenger's 102 scheduled flight 106 is likely to be oversold, the airline 118 can use the location (or other valuation factors) to offer low (or free) standby offers to board a different flight 106, thereby saving money by eliminating a need to bump a passenger 102A.

In another exemplary embodiment, the airline 118 also can use the location information of its passengers 102 as described above to determine which flights 106 are likely to be overbooked or underbooked. For example, if the airline 118 determines that many of a given flight's 106 passengers 102 are already at or near the airport, the airline 118 may be able to determine that the flight 106 is more likely to be overbooked; conversely, if many of a flight's 106 passengers 102 are far away from the airport as the flight 106 time approaches, the airline 118 may be able to determine that the flight 106 is likely to be underbooked and have capacity for standby passengers 102.

Any of the methods by which an airline 118 can communicate with passengers 102 regarding offers or counter-offers for standby or bumping bids 110 or fees can include various measures for confirmation and/or security. For example, where a smartphone, laptop, or other mobile Internet device application is used to foster communication between an airline 118 and a passenger 102, the mobile Internet device application or web-based application can prompt the passenger 102 to enter a password, credit card number, or other information to confirm the passenger's 102 identity prior to accepting a bid 110, 114 or changing the passenger's 102 flight 106. Alternatively, the mobile device may have some type of fingerprint scan, retinal scan, or other type of biometric device for authenticating the passenger 102. Similarly, if the communication between the airline 118 and passenger 102 is via text messaging or email messaging, the passenger 102 may be required to provide a password, confirmation number, or other type of identifying information.

Additionally, regardless of the form of communication (e.g., web-based application, smartphone application, PC application, text message), the airline 118 can include a variety of steps to transmit its counter-offer and allow the passenger 102 to accept. For example, whether the airline 118 is transmitting an initial offer (without the passenger 102 having submitted a bump bid 110 or standby bid 114) or a counter offer to a submitted bump bid 110 or standby bid 114, the offer can be transmitted to the passenger 102 specifying the incentive or fee, the new flight details, and a time window during which the passenger 102 can accept the offer or counter-offer. The passenger 102 can accept the offer or counter-offer by, for example, selecting an “accept” link on an application or replying with a phrase (e.g., “accept”) that was specified in the offer or counter-offer via text message. If the passenger 102 accepts the offer or counter-offer, the airline 118 then can transmit updated reservation details (e.g., confirmation number, new flight details) and/or an image of a boarding pass 116 for the new flight 106 to the passenger 102. If the passenger 102 does not accept the offer (whether by explicitly rejecting it, or by allowing the time window to expire), the airline 118 then may make another offer or counter offer to a different passenger 102. In an alternative embodiment, instead of transmitting offers to passengers 102 consecutively with a time window for acceptance, the airline 118 can transmit offers to multiple passengers 102 simultaneously which may be first-come first-served without an explicit time window. The airline 118 then can transmit a message to passengers 102 after a sufficient number of passengers 102 have accepted the offers or counter-offers, indicating that the offers or counter-offers have expired.

The exemplary methods and steps described in the embodiments presented previously are illustrative, and, in alternative embodiments, certain steps can be performed in a different order, in parallel with one another, omitted entirely, and/or combined between different exemplary methods, and/or certain additional steps can be performed, without departing from the scope and spirit of the invention. For example, although the exemplary methods and steps disclosed herein largely relate to airline 118 flights, the invention can be similarly used with any mode of transportation. Additionally, the invention also can be used in other contexts beyond transportation, where tickets can be oversold or undersold, and where wait list, standby lists, or the like are used to fill remaining seats. Accordingly, such alternative embodiments are included in the invention described herein.

The invention can comprise a computer program that embodies the functions described herein and illustrated in the appended flow charts. However, it should be apparent that there could be many different ways of implementing the invention in computer programming, and the invention should not be construed as limited to any one set of computer program instructions. Further, a skilled programmer would be able to write such a computer program to implement an embodiment of the disclosed invention based on the flow charts and associated description in the application text. Therefore, disclosure of a particular set of program code instructions is not considered necessary for an adequate understanding of how to make and use the invention.

The invention can be used with computer hardware and software that performs the methods and processing functions described above. Specifically, in describing the functions, methods, and/or steps that the airline 118 can perform in accordance with the invention, the airline 118 can accomplish any or all of these steps by using an automated or computerized process. As will be appreciated by those skilled in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

Although specific embodiments of the invention have been described above in detail, the description is merely for purposes of illustration. Various modifications of, and equivalent steps corresponding to, the disclosed aspects of the exemplary embodiments, in addition to those described above, can be made by those skilled in the art without departing from the spirit and scope of the invention defined in the following claims, the scope of which is to be accorded the broadest interpretation so as to encompass such modifications and equivalent structures.

What is claimed is:

1. A non-transitory computer-readable medium having computer-readable program code embodied therein for identifying passengers to board on a flight, the computer-readable program code comprising:
computer-readable instructions for determining if the flight is oversold or undersold;
computer-readable instructions for receiving, if the flight is oversold, valuation data indicative of a valuation from confirmed passengers for the flight to be bumped from the flight and selecting which confirmed passengers for the flight to be bumped from the flight based on the valuation data; and
computer-readable instructions for receiving, if the flight is undersold, valuation data indicative of a valuation from standby passengers for the flight to be placed on the flight and selecting which standby passengers for the flight to be placed on the flight based on the valuation data.

2. The non-transitory computer-readable medium of claim 1, wherein each respective valuation data comprises at least one of a bid associated with each respective passenger and a location associated with each respective passenger.

3. The non-transitory computer-readable medium of claim 1, wherein the flight is undersold.

4. The non-transitory computer-readable medium of claim 3, wherein the valuation data from each respective standby passenger comprises a location associated with each respective standby passenger.

5. The non-transitory computer-readable medium of claim 3, wherein the valuation data from each respective standby passenger comprises a standby bid associated with each respective standby passenger.

6. The non-transitory computer-readable medium of claim 1, wherein the flight is oversold.

7. The non-transitory computer-readable medium of claim 6, wherein the valuation data from each respective confirmed passenger comprises a bump bid associated with each respective confirmed passenger.

8. The non-transitory computer-readable medium of claim 6, wherein the valuation data from each respective confirmed passenger comprises a location associated with each respective confirmed passenger.

9. (canceled)

10. The non-transitory computer-readable medium of claim 8, wherein a location associated with at least one confirmed passenger is periodically updated after an initial location is identified, and
wherein the location is periodically updated after at least one of the confirmed passenger checking in for the flight, and a period of time prior to a scheduled departure time of the flight.

11. (canceled)

12. The non-transitory computer-readable medium of claim 1, wherein determining if the flight is oversold or undersold comprises:
identifying a location of a plurality of passengers for the flight; and
extrapolating the location of the plurality of passengers to estimate a likelihood of the flight being oversold or undersold.

13. The non-transitory computer-readable medium of claim 12, wherein identifying a location of at least one passenger for the flight comprises identifying a location of a device used by the at least one passenger to check-in for a flight, and
wherein the device comprises at least one of a kiosk, a personal computer, a mobile Internet device, and a cellular telephone.

14. The non-transitory computer-readable medium of claim 12, wherein identifying a location of at least one passenger for the flight comprises identifying a location of a mobile Internet device associated with the passenger.

15. (canceled)

16. The non-transitory computer-readable medium of claim 6, wherein receiving valuation data from confirmed passengers for the flight comprises receiving valuation data from a given confirmed passenger for the flight and associating the valuation data with any confirmed passenger traveling in a group with the confirmed passenger.

17. The non-transitory computer-readable medium of claim 14, wherein the flight is oversold,
wherein the valuation data from each respective confirmed passenger comprises a location associated with each respective confirmed passenger and a bid associated with each respective confirmed passenger,
wherein receiving valuation data from confirmed passengers for the flight comprises receiving valuation data from a given confirmed passenger for the flight and associating the valuation data with any confirmed passenger traveling in a group with the given confirmed passenger, and
wherein the selecting which confirmed passengers for the flight to be bumped from the flight based on the valuation data comprises determining a group size of each given confirmed passenger.

18. (canceled)

19. (canceled)

20. (canceled)

21. A non-transitory computer-readable medium having computer-readable program code embodied therein for selecting bump passengers to be bumped from a transportation vehicle, the computer-readable program code comprising:
computer-readable program code for receiving a bump bid for a plurality of bump passengers having a ticket to board the transportation vehicle; and
computer-readable program code for selecting at least one bump passenger to bump from the transportation vehicle based on the bump bid of the at least one bump passenger.

22. The non-transitory computer-readable medium of claim 21, wherein the bump bids received from bump passengers other than each respective bump passenger are inaccessible to each respective bump passenger when each respective bump bid is received from each respective bump passenger.

23. The non-transitory computer-readable medium of claim 21, further comprising computer-readable program code for indicating to at least one bump passenger via a video display to submit a bump bid.

24. The non-transitory computer-readable medium of claim 21, further comprising computer-readable program code for indicating to at least one bump passenger via a video display to submit a bump bid,
wherein the bump bids received from bump passengers other than each respective bump passenger are inaccessible to each respective bump passenger when each respective bump bid is received from each respective bump passenger, and
wherein each respective bump bid comprises an incentive that each respective bump passenger would accept to be bumped from the transportation vehicle.

25. The non-transitory computer-readable medium of claim 21, wherein the transportation vehicle has a number of needed seats, the number of needed seats being a number of total seats subtracted from a number of checked-in passengers,
wherein the number of needed seats and the bump bids for bump passengers other than each respective bump passenger are inaccessible to each respective bump passenger when each respective bump bid is received for each respective bump passenger.
wherein the computer-readable program code for receiving a bump bid for a plurality of bump passengers having a ticket to board the transportation vehicle comprises:
computer-readable program code for receiving a bump bid from a given bump passenger having a ticket to board the transportation vehicle;
computer-readable program code for associating the bump bid from the given bump passenger with any bump passenger traveling in a group with the given bump passenger; and
computer-readable program code for adjusting the bump bid based on additional factors, the additional factors comprising at least one of: a frequent flier status of the bump passenger, a fare class of the bump passenger, and a transportation class of the bump passenger,
wherein the plurality of bump passengers has a first bump passenger, the first bump passenger having bump bid with an associated cost being less than or equal to an associated cost of the bump bid of all other bump passengers in the plurality of bump passengers who have not already been selected to be bumped from the transportation vehicle, and
wherein the computer-readable program code for selecting at least one bump passenger to bump from the transportation vehicle based on the bump bid of the at least one bump passenger comprises:
computer-readable program code for determining a number of still-needed seats on the transportation vehicle, by subtracting a number of bump passengers already selected to be bumped from the transportation vehicle from the number of needed seats;
computer-readable program code for identifying the first bump passenger in the plurality of bump passengers;
computer-readable program code for identifying a group size of the first bump passenger, the group size being equal to a number of bump passengers traveling in the group with the first bump passenger including the first bump passenger;
computer-readable program code for selecting the first bump passenger and any bump passengers traveling in a group with the first bump passenger to be bumped from the transportation vehicle in response to a determination that the group size of the first bump passenger does not exceed the number of still-needed seats on the transportation vehicle; and
computer-readable program code for removing the first bump passenger and any bump passengers traveling in a group with the first bump passenger from the plurality of bump passengers.

26. The non-transitory computer-readable medium of claim 21, wherein the transportation vehicle has a number of needed seats, the number of needed seats being a number of total seats subtracted from a number of checked-in passengers,
wherein the number of needed seats and the bump bids for bump passengers other than each respective bump passenger are inaccessible to each respective bump passenger when each respective bump bid is received for each respective bump passenger.
wherein the computer-readable program code for receiving a bump bid for a plurality of bump passengers having a ticket to board the transportation vehicle comprises:
computer-readable program code for receiving a bump bid from a given bump passenger having a ticket to board the transportation vehicle;
computer-readable program code for associating the bump bid from the given bump passenger with any bump passenger traveling in a group with the given bump passenger; and
computer-readable program code for adjusting the bump bid based on additional factors, the additional factors comprising at least one of: a frequent flier status of the bump passenger, a fare class of the bump passenger, and a transportation class of the bump passenger,
wherein the plurality of bump passengers has a first bump passenger, the first bump passenger having bump bid with an associated cost being less than or equal to an associated cost of the bump bid of all other bump passengers in the plurality of bump passengers who have not already been selected to be bumped from the transportation vehicle, and
wherein the computer-readable program code for selecting at least one bump passenger to bump from the transportation vehicle based on the bump bid of the at least one bump passenger comprises:
computer-readable program code for determining a number of still-needed seats on the transportation vehicle, by subtracting a number of bump passengers already selected to be bumped from the transportation vehicle from the number of needed seats;
computer-readable program code for identifying the first bump passenger in the plurality of bump passengers;
computer-readable program code for identifying a group size of the first bump passenger, the group size being equal to a number of bump passengers traveling in the group with the first bump passenger including the first bump passenger;
computer-readable program code for selecting the first bump passenger and any bump passengers traveling in a group with the first bump passenger to be bumped from the transportation vehicle in response to a determination that the group size of the first bump passenger does not exceed the number of still-needed seats on the transportation vehicle; and
computer-readable program code for removing the first bump passenger and any bump passengers traveling in a group with the first bump passenger from the plurality of bump passengers.
